(19) United States
(12) Patent Application Publication
(10) Pub. No.: US 2011/0155888 A1
(43) Pub. Date: Jun. 30, 2011

(54) MOBILE POWER UNIT WITH PTO

(76) Inventor: JUSTIN JORDAHL, Alden, IA (US)

(21) Appl. No.: 12/872,702

(22) Filed: Aug. 31, 2010

Related U.S. Application Data
(60) Provisional application No. 61/238,380, filed on Aug. 31, 2009.

(51) Int. Cl. F16M 3/00

(52) U.S. Cl. 248/647

(57) ABSTRACT

A trailer is provided for providing a power source to an implement. The trailer includes an engine connected to a power takeoff shaft, which is connected to an implement requiring an external source of power to run the implement. The trailer includes a mounting member for attaching the trailer to a vehicle for hauling the trailer at highway speeds to a desirable location. The mounting member is such that a lone individual may attach and detach the trailer to a vehicle as required. The trailer may also include a storage tray, three-point hitch, and a plurality of outriggers as the situation requires. An engine control is also provided to control the function and to gauge the operation of the engine.

### CROSS-REFERENCE TO RELATED APPLICATIONS

This application claims priority under 35 U.S.C. §119 of a provisional application Ser. No. 61/238,380, filed Aug. 31, 2009, and which application is hereby incorporated by reference in its entirety.

### FIELD OF THE INVENTION

The present invention relates generally to a mobile trailer for performing stationary power take-off work. More particularly, though not exclusively, the present invention relates to a portable trailer including an engine, motor or other power generating means secured to a frame and operatively connected to one or more power take-off units.

### BACKGROUND OF THE INVENTION

Currently, larger farming operations require a great deal from their tractors. Tractors perform a multitude of tasks, many of which require the tractor's mobility during use, i.e. plowing, spraying and other tasks which require work be performed in a constantly moving manner. However, for many of the tasks, the tractor remains stationary. In such situations, it would be preferable to have a power unit which could operate more efficiently while freeing up a tractor for other use. It is therefore an object of the present invention to provide for a system which allows for much of the functionality of a tractor to be performed in a variety of locations without using the tractor.

Tractors also have difficulty traveling large distances. Typically a tractor must be hauled to a distant location or travel along highways or interstates at less than ideal travel speeds. Many accidents have resulted from tractors on roads travelling slowly relative to the rest of the traffic flow. It is therefore any object of the present invention to provide for a system which can perform much of the functionality of a tractor and which can be transported easily and at normal highway speeds.

Mobile PTO systems are known and not associated with a tractor. For example, one such system includes attaching multiple frames to a pickup having a gooseneck hitch in the bed of the pickup. The frames are attached to one another and to a second square hitch beneath the bumper of the pickup. One of the frames may include a power takeoff (PTO) power source. The PTO may be operatively secured to an implement to power the implement. However, problems exist with such mobile PTO systems. For example, such a system is very heavy and must stay attached to the pickup. A second machine must be used to load the system in the back of the pickup, which is time-consuming. In addition, there may not be a machine available when needing to lift the system to attach it to the pickup. A second problem is that the system must stay connected to the pickup, i.e. it is not a stand alone system. Therefore, if the pickup is needed elsewhere, the use of the system must be stopped until the pickup is available to continue to allow the system to provide power to the implement.

Therefore, there is a need in the art for a mobile PTO system which can be easily and readily transported, even moved with only manpower. There is also a need for an improved mobile PTO system that can be used in a stand alone manner to allow a person to use the transport vehicle, such as a pickup or tractor, for another task and/or at another location once the PTO system is in place near an implement.

### SUMMARY OF THE INVENTION

It is therefore a primary object, feature, and/or advantage of the present invention to provide an improved mobile power takeoff system that solves deficiencies in the art.

It is another object, feature, and/or advantage of the present invention to provide an improved mobile takeoff unit that can be used in a stand alone manner.

It is another object, feature, and/or advantage of the present invention to provide an improved mobile takeoff unit that can be attached to a pickup truck easily and quickly to be pulled to a desired location.

It is another object, feature, and/or advantage of the present invention to provide a mobile takeoff unit that has higher fuel efficiency than using a tractor power takeoff.

It is another object, feature, and/or advantage of the present invention to provide a mobile power takeoff unit that can travel at highway speeds.

It is another object, feature, and/or advantage of the present invention to provide a mobile power takeoff unit that can be used on unlevel ground.

It is another object, feature, and/or advantage of the present invention to provide a mobile power takeoff unit that provides for multiple power takeoff speeds.

These and/or other objects, features, and advantages of the present invention will be apparent to those skilled in the art. The present invention is not to be limited to or by these objects, features and advantages, and no single embodiment need exhibit every object, feature, and/or advantage.

According to one aspect of the present invention, a trailer is provided with a mobile power source for an implement requiring an external source of power. The trailer includes a frame, an adjustable mounting member, at least one axle, first and second wheels, an engine, an engine control unit, and a power source. The frame comprises a front end and an opposite rear end and is generally planar. The adjustable mounting member is positioned adjacent the front end of the frame. The axle is positioned adjacent the rear end of the frame and is rotatable. The first and second wheels are mounted on the axle. The engine is mounted on the frame between the axle and the adjustable mounting member, and the engine control unit is operatively connected to the engine. The power source transfer unit is mounted on the frame, and comprises a plurality of power takeoff shafts operatively connected to a drive train of the engine. The power takeoff shafts can be operatively connected to an implement.

According to another aspect of the present invention, a trailer is provided with a mobile power source for an implement requiring an external source of power is provided. The trailer includes a frame, an adjustable mounting member, a plurality of axles, a plurality of wheels, an engine, an engine control unit, a power source, a fuel tank, a storage tray, and a plurality of hydraulic outriggers. The frame comprises a front end and an opposite rear end and is generally planar. The adjustable mounting member is positioned adjacent the front end of the frame. The plurality of axles are positioned adjacent the rear end of the frame and are rotatable. The plurality of wheels are mounted on the axles. The engine is mounted on the frame between the axle and the adjustable mounting member, and the engine control unit is operatively connected to the engine. The power source transfer unit is mounted on the frame, and comprises a plurality of power takeoff shafts operatively connected to a drive train of the engine. The power takeoff shafts can be operatively connected to an implement. The fuel tank is mounted on the frame and operatively connected to the engine. The storage tray is mounted on the frame between the power source and the engine. The plurality of hydraulic outriggers are mounted on the frame and adapted to level the trailer.

### BRIEF DESCRIPTION OF THE DRAWINGS

FIG. 1A is a schematic of the major components of an embodiment of the present invention.

FIG. 1B is a side view of an embodiment of the mobile trailer with a power takeoff source of the present invention.

FIG. 2 is a side and rear perspective view of the trailer.

FIG. 3 is a perspective view of the power takeoff shafts of the trailer.

FIG. 4 is a view of the engine control unit of the trailer.

FIG. 5A is a schematic of the major components of another embodiment of the trailer of the present invention.

FIG. 5B is a front and side perspective view of an additional embodiment of a mobile trailer of the present invention.

FIG. 6 is a perspective view of a storage tray mounted on the trailer.

FIG. 7 is a view of a three-point hitch mounted on the trailer.

FIG. 8 is a view of the trailer with a plurality of hydraulic outriggers raising the frame of the trailer.

FIG. 9 is view of a plurality of hydraulic controls used with a plurality of hydraulic outriggers to level the frame of the trailer.

FIG. 10 is a view of the trailer connected to and powering an implement.

### DETAILED DESCRIPTION OF THE PREFERRED EMBODIMENTS

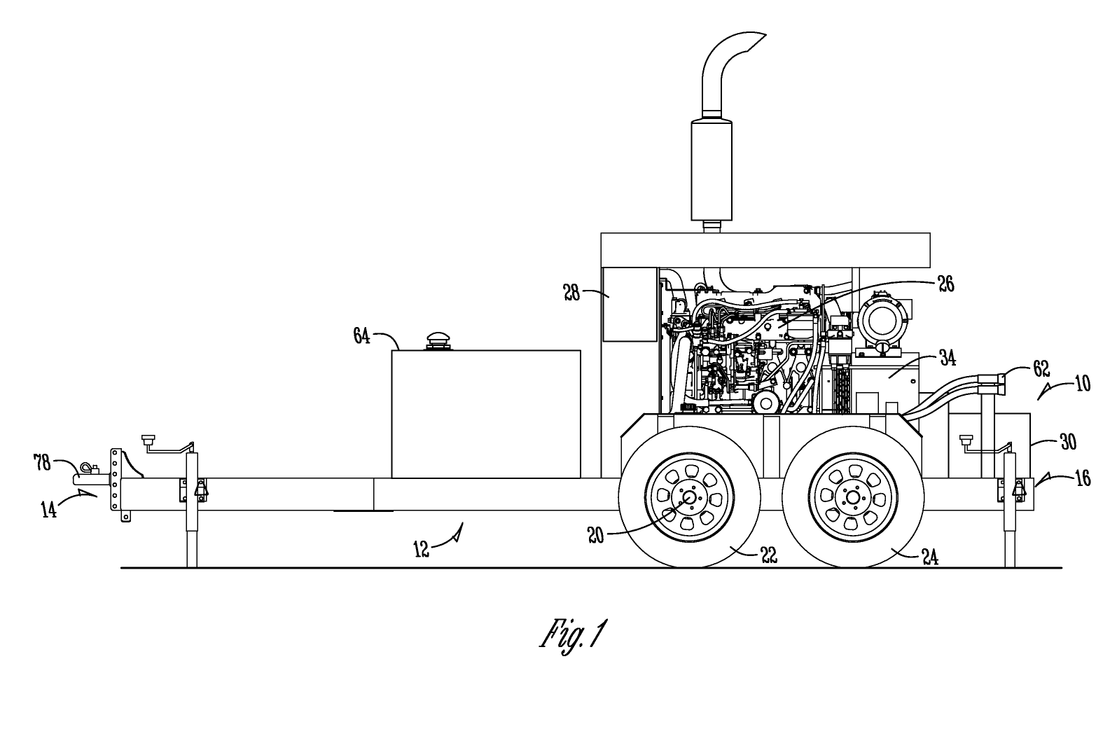

FIGS. 1A and 1B show a side view of an embodiment of the mobile trailer 10 with a power takeoff source 30. The trailer 10 includes a frame 12, which comprises sections of tubular steel beams connected together to form a generally planar top. The frame includes a front end 14 and an opposite rear end 16. The rear end 16 of the frame 12 will be generally rectangular shaped to allow a number of items to be mounted on said frame. Positioned adjacent the front end 14 is a mounting member 18. The mounting member may be a ball hitch receiver that is adjustable in height. The ball hitch receiver, or mounting member 18, can be mounted on a tube which includes a plurality of holes. The tube may be slidable within a larger tube wherein a set of holes can be lined up. The location of the chosen holes will determine the height of the adjustable mounting member 18. A pin, which may be a cotter pin or a nut and bolt, is placed in the corresponding holes to lock the mounting member at a desired height in place. The adjustability allows the trailer 10 to be pulled by a variety of vehicles.

Positioned near the rear end 16 of the frame 12 will be at least one axle 20. While only one axle is required, FIGS. 1A and 1B show an additional second axle as well. The additional axle will decrease the amount of weight that the trailer 10 is able to hold in transport. In a preferred embodiment, twin 7,000 pound axles are operatively secured to the trailer and connected to wheels 22, 24. The wheels may be 16 inch wheels. In addition, each wheel includes an electric brake (not shown) operatively connected to the wheel such that the brakes ensure adequate stopping power.

Mounted on the frame 12 of the trailer 10 is an engine 26. The engine is generally positioned on the frame either directly above the axles or between the axles and the mounting member 18. This distribution of weight will ensure that the trailer will not tip and will travel in a most efficient manner. In a preferred embodiment, the engine is capable of producing a 150 horsepower at 1800 rpm. Also mounted on the frame and operatively fastened to the engine is an engine control unit 28. The engine control unit controls the throttling, starting, and gauging of the engine and fluids within the engine, as will be discussed in greater detail below. Connected to a drive train 34 of the engine is a power source transfer unit 30. The power source transfer unit includes at least one power takeoff (PTO) shaft 32. In a preferred embodiment, dual output PTO shafts will be provided. The power source transfer unit 30, including the PTO shafts 32, is mounted adjacent the rear end 16 of the frame 12. The PTO shafts 32 are configured to connect to an implement 36 requiring an external power source. The connection and use of the PTO shafts will be discussed in greater detail below.

In a preferred embodiment, the dual output PTO shafts include a 540 and a 1000 rpm output shaft. While these specific rpm outputs are given, it should be appreciated that additional outputs may be provided for use with specific implements. It should also be appreciated that pulleys and gearing will be used to reduce the rotation from the 1800 rpm output of the drive train to the required output of the PTO shaft. For example, any number of gear combinations or pulley combinations may be used to reduce the 1800 rpm of the engine drive train to the approximate 540 rpm of the PTO shaft output. There may also be a clutch (not shown) used with the motor between the engine and the PTO shaft. Further shown in FIGS. 1A and 1B is a fuel tank 64 mounted on the frame 12 of the trailer 10. The fuel tank includes fuel to run the engine. While the fuel tank is shown mounted forward of the engine, it should be appreciated that the fuel tank may be mounted on the frame anyplace where space is available on the frame.

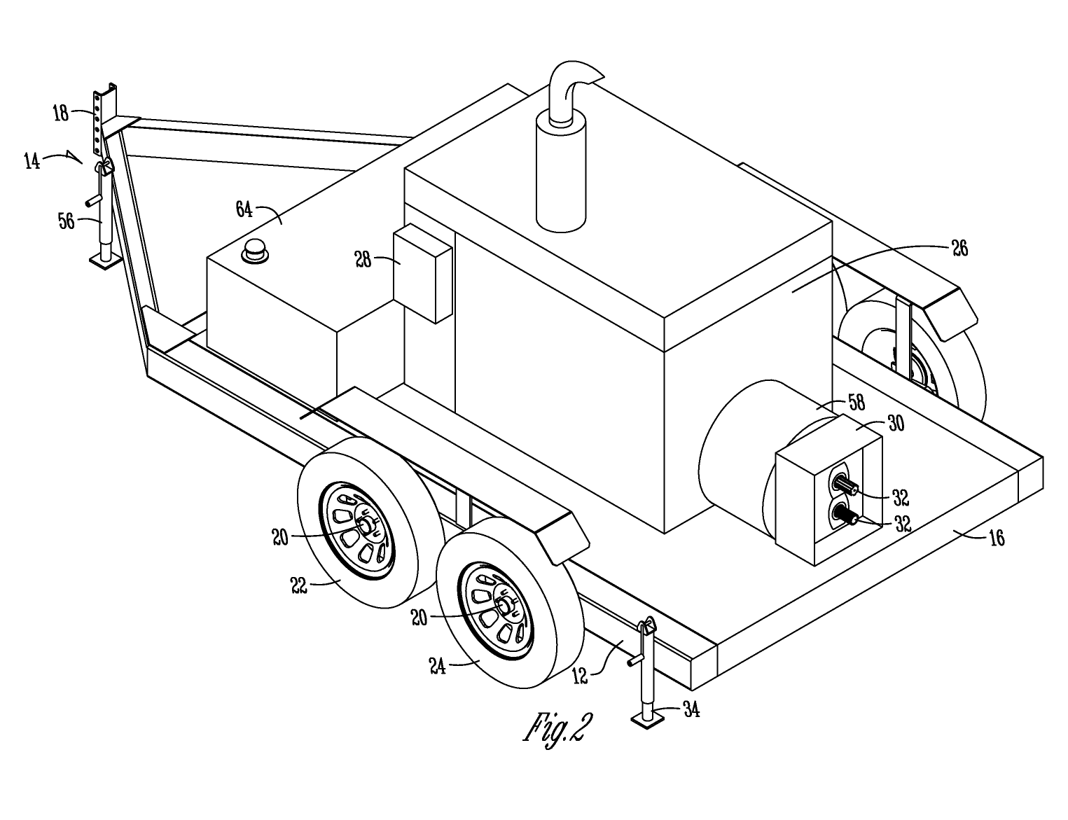

FIG. 2 is a side and rear view of the trailer 10. FIG. 2 shows a better view of the PTO shaft 32 mounted at the rear end 16 of the frame 12 of the trailer 10. In a preferred embodiment, the engine 26 is a Tier 3 diesel engine providing greater efficiency and the required output. The use of the engine in the stand-alone manner as provided, may save over three gallons of fuel per hour. Thus, running a Tier 3 engine at 1800 rpms for 800 hours per year at full PTO shaft speed may save over 2,000 gallons of fuel per year. Additionally, the engine may be any diesel engine capable of producing the appropriate power output while still running in an efficient manner.

Also shown in FIG. 2 is a lift member 56 mounted at the front end 14 of the frame 12. The lift member helps to attach the trailer 10 to a vehicle, while also allowing the trailer to be used in a stand-alone manner. For example, the lift member 56 includes a handle connected to a first and second tube. The first tube is larger than the second tube and surrounds the second tube. The second tube includes a flat bottom. To raise the front end of the trailer, the handle is rotated to move the second tube relative to the first tube. Continued rotation of the handle will raise the front end, which may raise the mounting member 18 above a hitching member of a vehicle. When the trailer is to be used as a stand-alone device, the front end of the trailer is raised to disengage the mounting member 18 from the hitching member of the vehicle to allow the vehicle to pull away from the trailer. Because the lifting member 56 remains on the ground and holds the trailer in place, the engine may still be run to power the power source transfer unit 30 without the trailer being hooked up to a vehicle. This allows a vehicle to be used at a separate location while still using the trailer to power an implement.

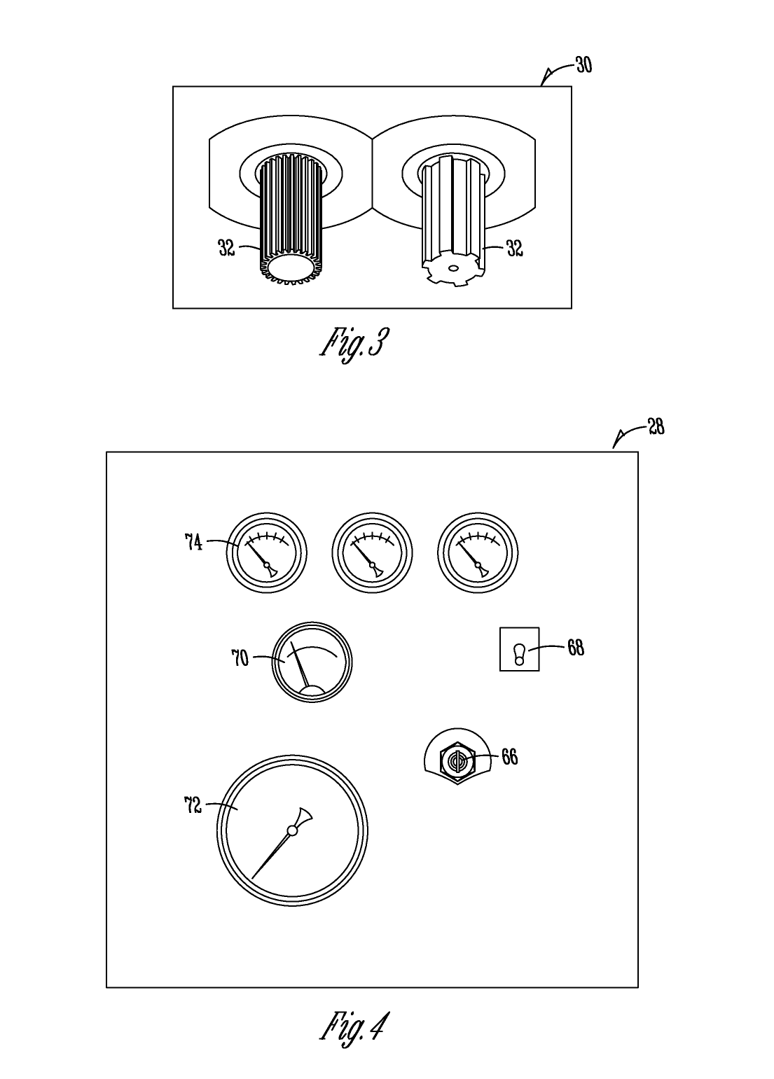

FIG. 3 is a view of the power source transfer unit 30 showing the PTO shafts 32 of the trailer 10. The PTO shafts may be oriented in a horizontal or vertical manner, as may be desired by a user. In addition, only one PTO shaft may be required per trailer 10. However, as shown in FIG. 3, PTO shafts are generally splined so as to allow easy attachment to an implement. The splined shafts also ensure that the PTO shaft does not slip or become detached while powering an implement.

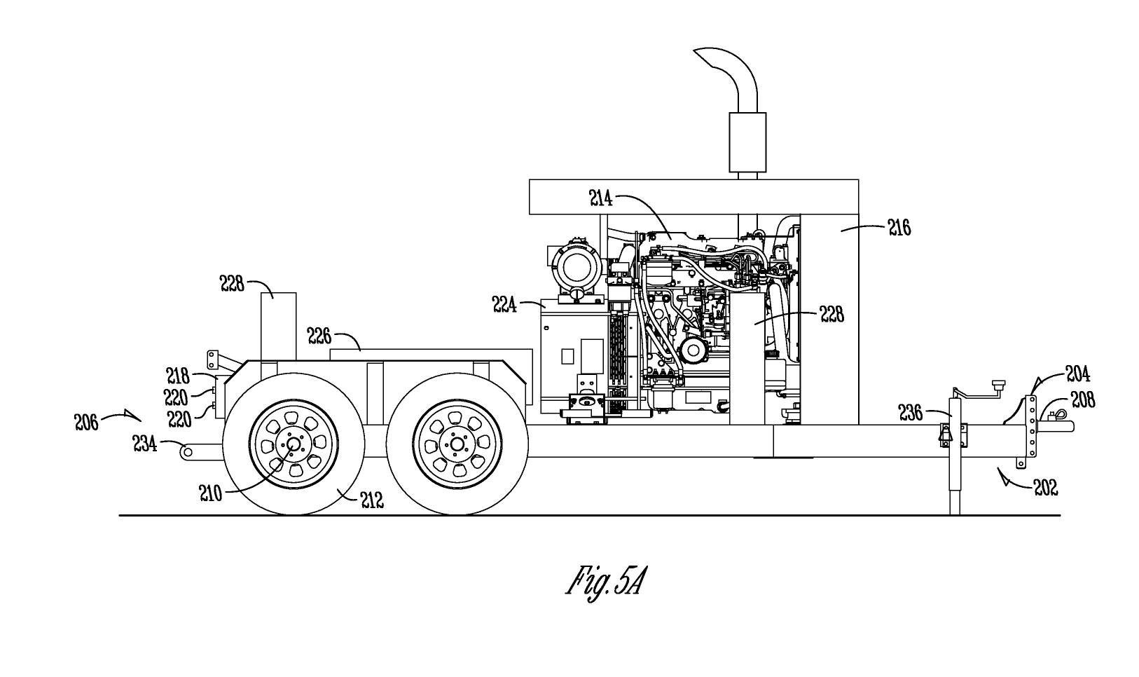

FIG. 4 is a view of the engine control unit 28 of the trailer 10. As shown in FIG. 4, the engine control unit 28 may include a number of gauges and switches. For example, the engine control unit 28 of FIG. 4 includes an ignition and throttle switch 66. The switch 66 is used to both turn on the engine, and to throttle the engine to increase the power. Also included in the engine control unit is a shut-off switch 68 for use when an emergency requires shutdown of the engine. A fuel gauge 70 is provided in the engine control unit to view the amount of fuel remaining in the fuel tank 64. The fuel gauge 70 ensures that the user will know when the trailer 10 is getting low on fuel so as to add new fuel to the fuel tank. A tachometer 72 is provided to allow an operator to view the rotations per minute (rpm) of the engine so as to ensure that the engine does not overheat or run harder than necessary. The tachometer 72 allows the operator to ensure that the engine is operating at the ideal speed for best efficiency. A number of other gauges 74 are also provided. The additional gauges may include an electrical gauge, a temperature gauge, a hydraulic fluid gauge, or the like. These additional gauges are generally safety gauges to determine if a problem exists and how to fix a problem with the mobile trailer 10.

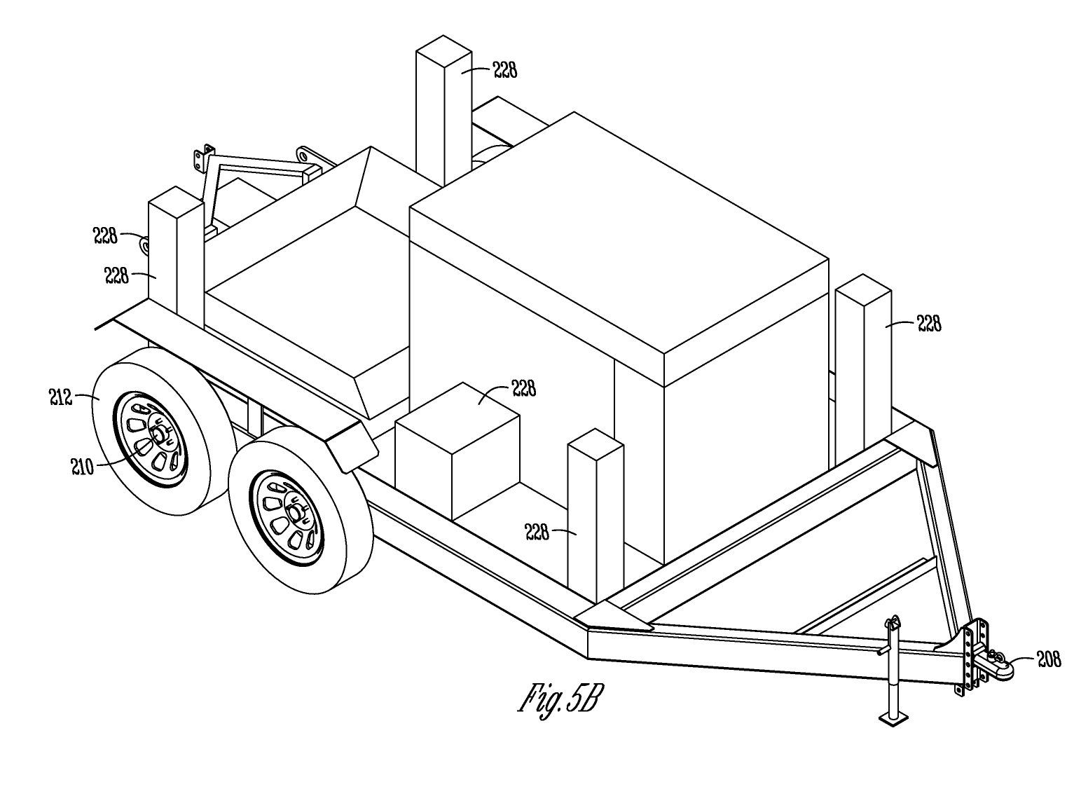

FIGS. 5A and 5B show an additional embodiment of mobile trailer 200 of the present invention. The trailer 200 includes additional features not shown in the embodiment of in FIGS. 1A and 1B. While trailer 200 also includes a generally rectangular and planer frame 202 constructed of steel beams, the frame may be larger. The frame also includes a front end 204 and opposite rear end 206. Adjacent the front end of the frame are an adjustable mounting member 208 and a lift member 236 for attaching the trailer 200 to a variety of vehicles. The trailer 200 includes a plurality of axles 210, which may be the same 7,000 pound axles as described above. The axles may also include the same 16″ wheels 212 as described above. Between the axles and the mounting member may also be an engine 214. The engine, as described above, may be a Tier 3 diesel engine, or any other internal combustion engine, for providing power through a drive train 222 to a power source transfer unit 218. The power source transfer unit 218 of the embodiment may also include a plurality of power take-off (PTO) shafts 220. The PTO shafts are configured to connect to an implement requiring an external source of power.

Also included with trailer 200 is a storage tray 226, a plurality of hydraulic outriggers 228, a three-point hitch 234, and hydraulic and electrical hookups 238, 248.

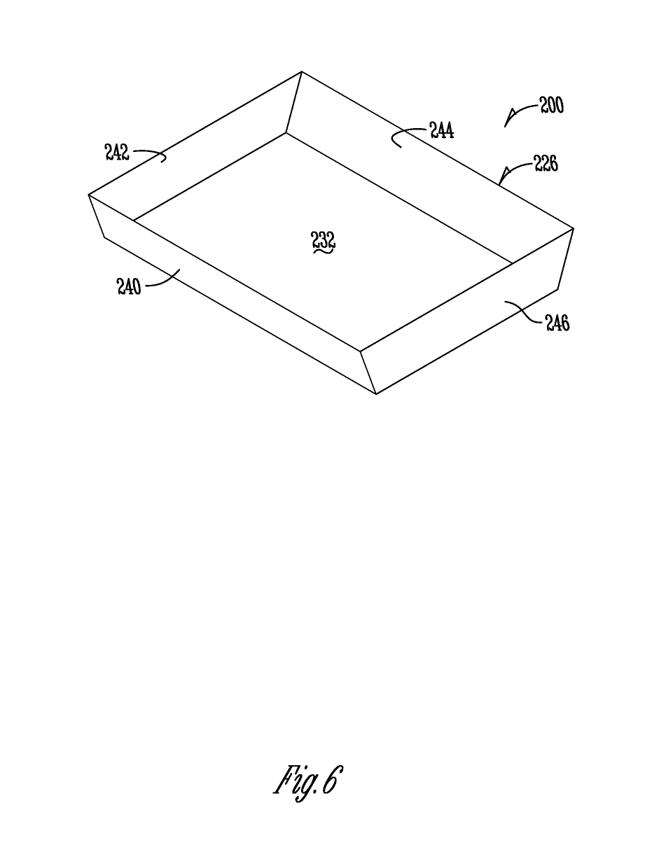

FIG. 6 is a perspective view of a storage tray 226 as shown mounted in the trailer 200. The storage tray comprises a generally rectangular and planar bottom surface 232 surrounded by a generally upwardly extending first wall 240, second wall 242, third wall 244, and fourth wall 246. The ends of the walls are connected to form an enclosed area of the storage tray. The storage tray may be used for storing tools or the like for use with the trailer 200 and/or anything else.

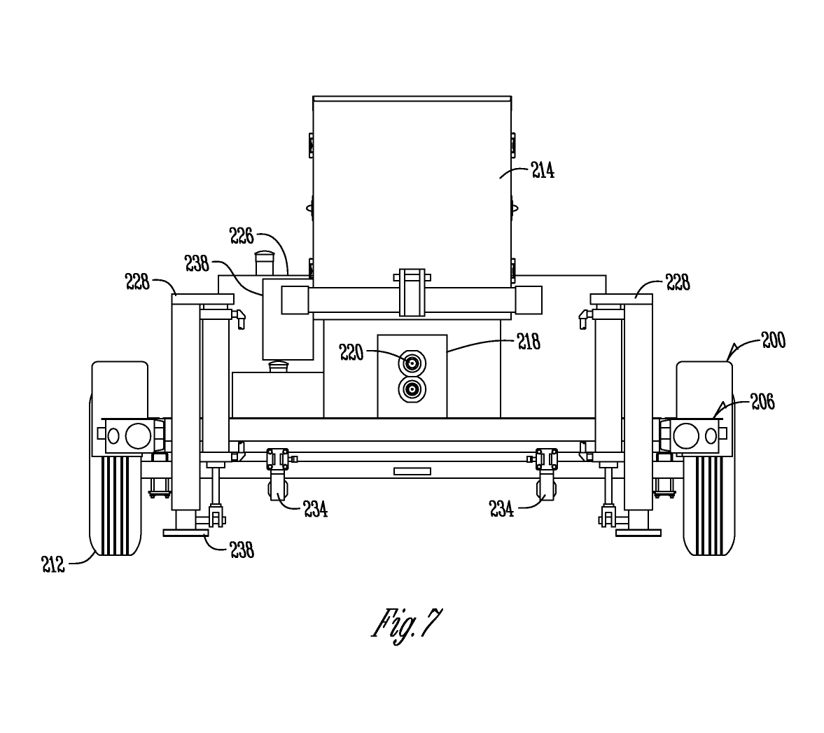

FIG. 7 is a view of a three-point hitch 234 mounted on the rear end 206 of the frame 202 of the trailer 200. The three-point hitch 234 is a standard three-point hitch used to connect to implements. The three-point hitch includes arms that are adjustable for CAT. I and CAT. II 2500 pound lifts. These lifts are also preferably operated by hydraulic actuators which are powered by the hydraulic pressure generated by a hydraulic pump connected to the motor. This allows the trailer 200 to connect to an implement to transport the implement along with the mobile trailer to a desired location. Also shown in FIG. 7 is the power source transfer unit 218. The power source transfer unit, as noted above, includes a plurality of PTO shafts 220. As discussed above, the PTO shafts 220 are splined shafts for connecting to an implement. Additionally, hydraulic hookups 238 and electrical hookups 248 may be included and mounted on the frame 202 of the trailer 200. The hydraulic and electrical hookups 238, 248 may be used to power implements or other devices as required at the location of the use of the trailer 200. The hookups are also powered by the attached engine. Also shown in FIG. 7 is the plurality of hydraulic outriggers 228, used for leveling the trailer.

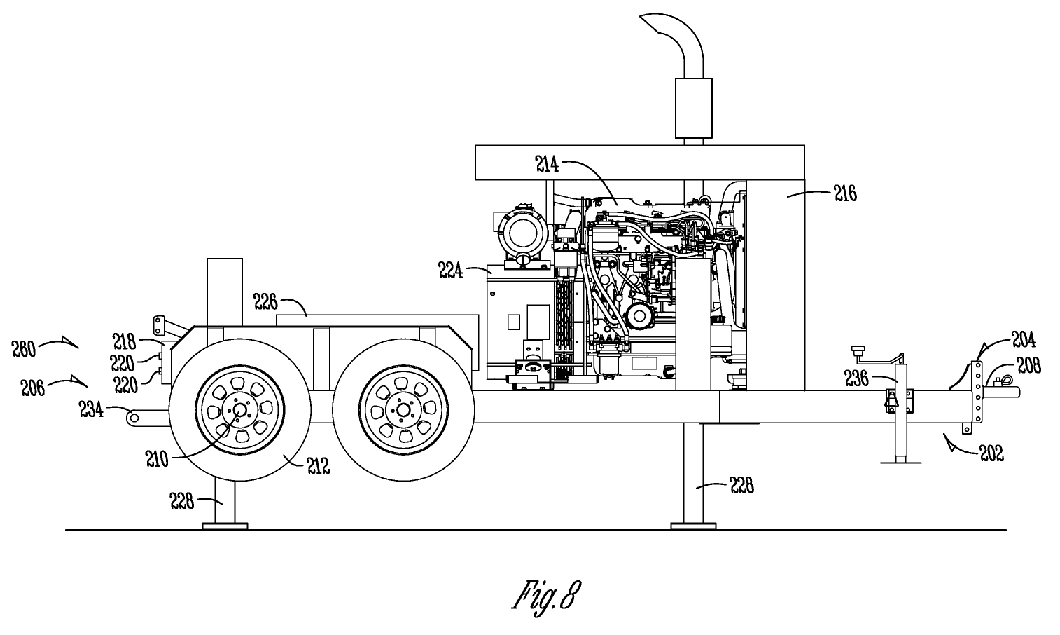

FIG. 8 is a view of the trailer 200 with the plurality of hydraulic outriggers 228 raising the trailer 200 to level the trailer. As discussed above, a lift member 236 may be used to lift the front end 204 of the frame 202. However, when the trailer 200 is needed to be used in unlevel or varying level terrain, the use of hydraulic outriggers will be necessary. The outriggers 228 are spaced about the frame 202 of the trailer 200 and are operatively connected to a hydraulic pump (not shown) run by the engine. When in position, the lift member 236 is used to detach the trailer 200 from the vehicle. The plurality of hydraulic outriggers 228 are then used to raise the trailer to ensure that the frame remains generally horizontal such that that engine will not be disturbed and so that the PTO shafts 220 will remain generally horizontal.

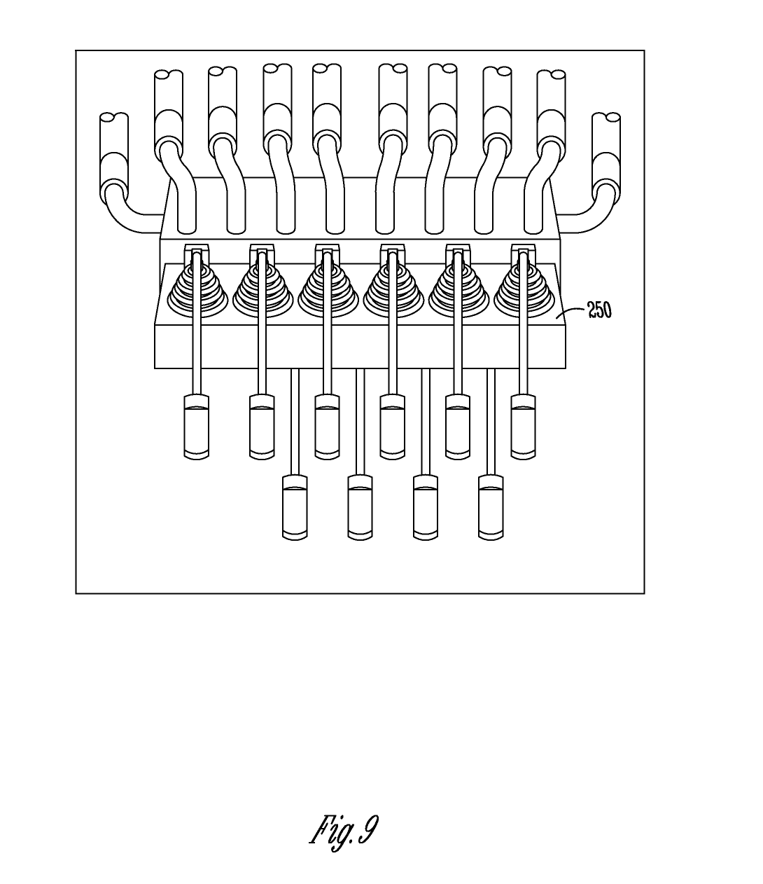

FIG. 9 is a view of a plurality of hydraulic controls operatively connected to the plurality of hydraulic outriggers 228 and the hydraulic pump. The plurality of hydraulic controls 250 are used to control the height of the hydraulic outriggers. Therefore, the controls determine when the outriggers will be used, and which ones need to be raised or lowered to level the frame of the trailer. The hydraulic controls also control any device connected to the hydraulic hookups 238.

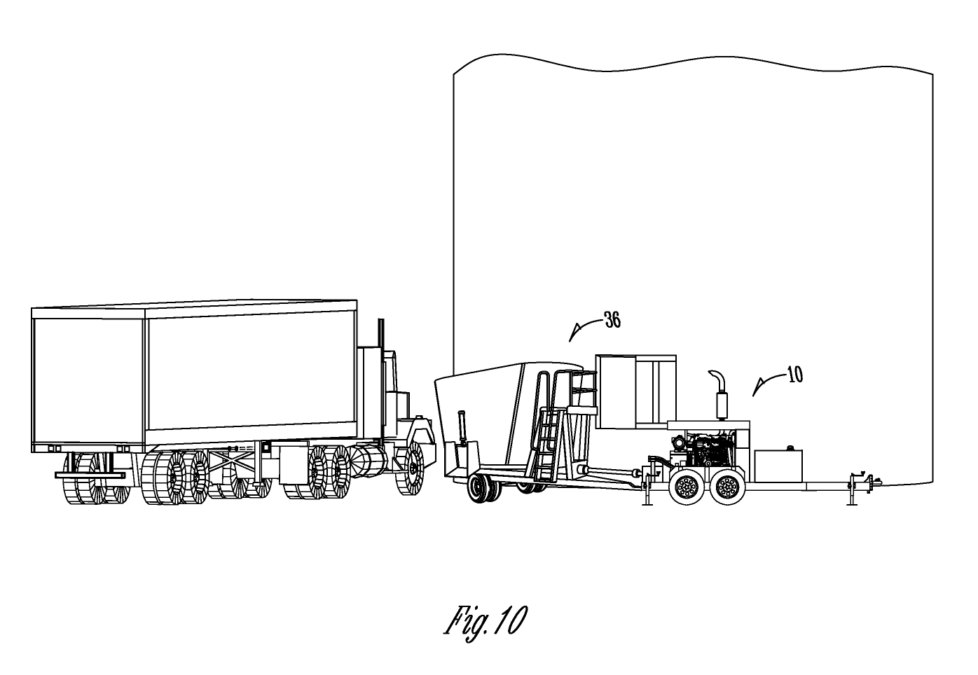

FIG. 10 is a view of the trailer 10 connected to and powering an implement 36. As stated above, an implement, such as grain vacuums, wood chippers, manure pumps, or the like, require an external power source to operate. The implements 36 operate by connecting a shaft from the PTO shaft 32 of the trailer 10 to a shaft in the implement itself.

In use, therefore, the present invention works as follows. A trailer 10 is connected to a vehicle by a mounting member 18. The mounting member may be a ball hitch attaching to a ball on the rear of a pickup. The pickup is able to haul the trailer 10 at highway speeds to a location where an implement needs an external power source. For example, as shown in FIG. 10, the implement is a grain vacuum for loading a truck with grain from a grain bin. The pickup takes the trailer to a position near the grain vacuum. Then, the pickup may detach from the mounting member 18 of the trailer to be used elsewhere. An operator connects a PTO shaft of the trailer to a receiving member of the implement. The engine on the trailer is then turned on to power the PTO shaft via a drive train of the engine to power the implement. In the example shown, the PTO shaft powers the grain vacuum to remove grain from the grain bin to place it in the back of a semi-trailer. Once the desired function of the trailer has been complete, an operator may attach the mounting member 18 to a vehicle, where the vehicle is able to haul the trailer to either a next implement or to a storage unit. The attachment and detachment of the trailer can be accomplished by a lone individual, which makes the use of the trailer 10 more practical.

The invention has been shown and described above with reference to the preferred embodiments, and it is understood that many modifications, substitutions, and additions may be made within the intended spirit and scope of the invention. The invention is only to be limited by claims appended hereto.

What is claimed is:

1. A trailer for providing a towable mobile power source for an implement requiring an external source of power, comprising:
a frame comprising a front end and an opposite rear end, the frame having a generally planar bed;
an adjustable mounting member positioned adjacent the front end of the frame;
an axle positioned adjacent the rear end of the frame;
a first wheel and a second wheel mounted on the axle;
an engine mounted on the frame between the axle and the adjustable mounting member;
an engine control unit operatively connected to the engine; and
a power source transfer unit mounted on the frame, the power source transfer unit comprising a plurality of power takeoff shafts operatively connected to a drive train of the engine;
wherein at least one of the plurality of power takeoff shafts can be operatively connected to an implement to power the implement.

2. The trailer of claim 1 further comprising a three-point hitch positioned adjacent the rear end of the frame.

3. The trailer of claim 1 further comprising a storage tray mounted on the frame, the storage tray comprising generally planar and rectangular bottom surface surrounded by a first wall, a second wall, a third wall, and a fourth wall.

4. The trailer of claim 3 wherein the storage tray is positioned rearwardly of the engine on the frame.

5. The trailer of claim 1 further comprising a first brake operatively connected to the first wheel.

6. The trailer of claim 5 further comprising a second brake operatively connected to the second wheel.

7. The trailer of claim 6 wherein the first and second brakes are electric brakes.

8. The trailer of claim 1 further comprising a plurality of lift members mounted on the frame.

9. The trailer of claim 8 wherein the plurality of lift members comprise mechanical lifts.

10. The trailer of claim 8 wherein the plurality of lift members comprise hydraulic outriggers.

11. The trailer of claim 1 wherein the engine is an internal combustion engine.

12. The trailer of claim 1 wherein the engine comprises a throttle.

13. The trailer of claim 1 wherein the plurality of power takeoff shafts comprise splined shafts.

14. The trailer of claim 1 further comprising electrical hookups mounted on the frame.

15. The trailer of claim 1 further comprising a plurality of remote hydraulic hookups mounted on the frame.

16. The trailer of claim 1 further comprising a fuel tank mounted on the frame and operatively connected to the engine.

17. A trailer for providing a self-contained mobile power source for an implement requiring an external source of power, comprising:
a frame comprising a front end and an opposite rear end, the frame being generally planar;
an adjustable mounting member positioned at the front end of the frame;
a plurality of axles positioned adjacent the rear end of frame, the plurality of axles configured to rotate relative to the frame;
a plurality of wheels mounted on the plurality of axles;
an engine mounted on the frame between the plurality of axles and the adjustable mounting member;
an engine control unit operatively connected to the engine;
a power source transfer unit operatively mounted on the frame, the power source transfer unit comprising a plurality of power takeoff shafts operatively connected to a drive train of the engine;
wherein at least one of the plurality of power takeoff shafts can be operatively connected to an implement to power the implement;
a fuel tank mounted on the frame and operatively connected to the engine;
a storage tray mounted on the frame between the power source and the engine; and
a plurality of hydraulic outriggers mounted on the frame and adapted to level the trailer.

18. The trailer of claim 16 further comprising a plurality of electric brakes operatively connected to the plurality of wheels.

19. The trailer of claim 16 wherein the storage tray comprises a planar and rectangular bottom surface, and a plurality of side walls extending generally upwardly from the bottom surface.

20. The trailer of claim 16 wherein the engine is free from drive power from a vehicle.
